(19) United States
(12) Patent Application Publication
(10) Pub. No.: US 2007/0044368 A1
(43) Pub. Date: Mar. 1, 2007

(54) Snag-resistant and attractive fishing flies - design and method for construction

(76) Inventor: Steven William Duckett, Klawock, AK (US)

Correspondence Address: Steven W. Duckett, P.O. Box 465, Klawock, AK, 99925-0465, US

(21) Appl. No.: 11/212,427

(22) Filed: Aug. 26, 2005

(51) Int. Cl. A01K 85/08; A01K 85/00

(52) U.S. Cl. 43/42.25; 43/42.39; 43/42.4; 43/42.43

(57) ABSTRACT

Snag-resistant and attractive fishing flies are disclosed. The design employs a filamentary loop on the side opposite the hook point, with weights attached to the filament to form a weighted keel that keeps the fly hook-point up in use. The weights may be moveable beads strung along a springy nylon monofilament so that the fly can bounce off the bottom and the beads can click, sending out sonic signals. Very little weight is needed to keep the fly riding with the hook-point up, because the keel is offset from the hook shank, providing much more leverage than prior art. This bouncing, talking keel structure can be fine-tuned for best action and applied to many well known fly patterns. Variations include continuing the keel filament around the hook point to form a weed-guard, and composing some of a filament on the hook-point side from foam to lighten the fly and stabilize it hook-point up and snag-resistant.

### CROSS-REFERENCE TO RELATED APPLICATIONS

This application claims benefit of the filing of a provisional application on 30 Aug. 2004 entitled “Design and Method for Constructing Fishing Flies That Are Snag-Resistant and Attractive to Fish”.

### STATEMENT REGARDING FEDERALLY SPONSORED RESEARCH OR DEVELOPMENT

Not Applicable

### REFERENCE TO SEQUENCE LISTING, ETC COMPACT DISK

Not Applicable

### BACKGROUND OF THE INVENTION

In the method of fishing called fly fishing, the line is heavier than the “fly”, so a skillful cast of the heavy flyline carries the lighter fly along with it toward the target. Many of the objects collectively called “flies” do not float on the surface to represent winged insects, but rather sink to portray small fish, crustaceans or underwater nymphal forms of various insects. Such flies are often weighted to make them sink better, but normal weighting—such as wrapping lead wire around the hook, or threading a bead on the hook—allows the weight of the hook point to turn the fly so it falls and swims hook-point down, resulting in snagging on the bottom and thus often the loss of the fly.

Prior art which addresses this problem requires building the fly with the majority of the light and water-resistant materials on the point side of the shank of the hook, and with the weighting material bound to the opposite side of the shank; in this way, there is a torque on the hook causing it to turn point up to reduce snagging on the bottom. Because the weight is fairly small (since the fly must be lighter than the line for casting) and the weight is bound directly to the shank, which is near the center of rotation of the fly, there is not a large lever moment, so the fly often turns sideways and is not effective. In addition, a single heavy weight bound to the shank of the hook does not usually add to the attractiveness of the fly to the fish, and the fixed weight may cause the fly to swim and dive in a way that may not be appropriate for the particular fishing application.

Prior art appears to be mainly common knowledge and unpatented standard practice. Two common methods for weighting flies, namely lead wrapping and bead heads, do not result in any torque to keep the hook-point up. Two other common methods are metal eyes (fly examples: Clousers, Charlies) and lead tape (fly example: zonkers); these methods can result in torque, but since the weight is bound closely to the shank of the hook, there is a short lever arm and thus very little torque for a given amount of weight, which is the reason that these weights are usually made of environmentally objectionable metals with low attractiveness to fish.

### SUMMARY OF THE INVENTION

A new design and method for snag-resistant and attractive flies is disclosed herein. This innovation incorporates a keel which provides sufficient torque on the fly so it travels hook-point up. This construction results in a fly that gets down to the bottom, but seldom snags, due to the springy, weighted keel, which keeps the fly's hook-point away from the bottom and bounces the fly out of harm's way. In addition, the moveable weights strung along the keel may click together and against the bottom, sending out sonic signals to the fish. The bouncing, talking keel structure can be advantageously applied to many standard fly patterns well known to those skilled in the art of fly-tying and fly fishing.

Very little weight is needed to keep the fly riding with the hook-point up, because the keel is offset from the hook shank, providing much more leverage than conventional lead-eye tying methods, which bind the weighted eye to the hook shank. This allows the use of environmentally friendly materials for the weights, such as glass and plastic, as opposed to the lead and brass customarily required in prior art. Additionally, a fly made with this innovation will ride hook up even if the main body of the fly is symmetrical (like a woolly bugger), whereas conventional methods usually require that the majority of the fibers and feathers are on the hook-point side of the shank (like fly patterns known as Charlies or Clousers).

The method does not interfere with the normal steps of constructing fly patterns, such as wrapping thread, winding hackle feathers, affixing fur and hair etc. The design and construction allow “fine tuning” of the weighting so that the fly may sink level, or head-first or tail-first, according to the desired action in use, as opposed to weighted-eye methods of prior art in which the weight is bound to the shaft in a fixed position. In addition to providing fish-attracting noise, the beads or weights may provide color and flash which are also attractive to fish. When the filamentary loop of this method is made of a springy material—like nylon monofilament—the resultant keel structure tends to bounce the fly off the bottom on contact, providing additional snag-resistance compared to prior art. Further embodiments of the basic keel structure include continuing the keel filament around the hook point to form a weed guard, and composing some of a filament on the hook-point side from a buoyant material such as foam to lighten the fly and stabilize it hook-point up and snag-resistant.

### DESCRIPTION OF THE DRAWINGS

FIG. 1 shows a basic embodiment, wherein the keel structure is a filamentary loop (106) loaded with one or more weights (107), and affixed to the hook on the side opposite the hook point (101) so that the force of gravity and the lever moment (108) of the weighted loop will cause the fly to ride point up in the water. The filamentary loop is normally affixed to the hook shank (103) near the start of the bend (102) and at a point (109) near the eye (104) of the hook. The usual part of the fly's structure (wing, tail, body, hackle, flash etc) is shown schematically in the cross-hatched region (105) since these parts vary greatly according to design of any particular fly pattern. Prior art commonly affixed a rigid weight to a point (110) on the underside of the shank, which provides very little torque for a given weight.

FIG. 2 shows a common method of affixing the filament (201), by lashing one end of said filament to the shank of the hook using standard practice of thread wraps (202); the free end of the filament projects to the rear and therefore does not interfere with the construction of the rest of the fly using standard fly-tying practice.

FIG. 3 shows a variant in which the filament (301) is attached to the bend of the hook (302); the Figure shows (schematically) the main parts of a standard fly pattern (307), and the lower section of the filament loaded with weights (306) and tied in (305) near the eye along with the end of the upper section of the filament (303), thereby making both a keel and a weed guard. One or more portions of the upper part of the loop may be made of a low-density material (304), which further increases the torque to keep the fly hookpoint up in the water, without materially increasing the overall weight of the fly.

FIG. 4 is a black-and-white view to show the “ornamental effect” of the fur, feathers etc. of the standard “fly dressing” of a well-known fly pattern containing the disclosed innovation. In the conventional version of this pattern the tail (401) and hackle (402) materials are very light, so the heavy bend and point (403) of the hook cause the fly to ride hookpoint down, but in the disclosed innovation the beads (405)—well offset from the shank of the hook—cause the fly to ride as shown; in addition some of the beads (404) may be made of colorful or noisy materials to enhance the attractiveness of the fly, and the distribution of heavy and lighter beads may be chosen to enhance the way in which the fly swims and dips on the retrieve when fishing.

FIG. 5 shows the “ornamental effect” of using shiny beads (504) as the weights to add flash and attractiveness to the fly. In some cases, parts like the tail (501), eyes (502) and wing (503) may be attached to the hook before affixing the filament and loading it with weights to form the keel structure which is disclosed herein.

### DESCRIPTION OF THE INVENTION

We use the word “Bouncer” to denote a fishing fly made according to the snag-resistant and fish-attracting design disclosed herein. When we refer to a standard pattern made according to the Bouncer technique, we will often prefix the word “Bouncer” with the name of that standard pattern (e.g. WoollyBugger Bouncer, Zonker Bouncer). This description mainly describes a common embodiment wherein the filament is nylon monofilament—commonly known as “mono”—and the weights are flashy beads free to move along the filament, but it is understood that the methods may apply to alternative filaments and weighting materials.

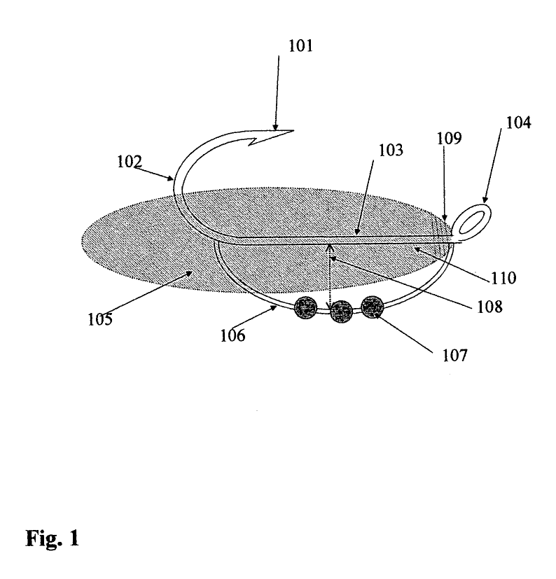

In one embodiment, FIG. 1, the springy keel (106) is formed from a medium-stiff piece of mono with a number of beads (107) strung along the mono. Because these weights are concentrated on the filament well offset from the shank (103) of the hook, there is a large lever arm (108) and thus significant torque to counter the torque of the hookbend (102) and hook-point (101). Because even small, lightweight beads will produce adequate torque, there is freedom to choose them for attractiveness, noise, sink-rate, etc. The beads can be small or large, metal plastic or glass, packed together or relatively free to move according to the requirements of the fly size and pattern. Almost any hook will work, but for freshwater flies a good hook is a nymph hook with an angled eye (104). In this embodiment, the standard dressing of the fly (105) is done, all or in part, before the beaded keel is tied in (109) near the eye of the hook. For reference, we show the place where the conventional metal eye of prior art would have been lashed to the shank (110); note that this position gives very little lever arm and thus little torque to counter the torque of the hookbend (102) and hook-point (101)—especially since a part of the prior-art weight (e.g., lead eyes, lead tape) commonly extends into the hookpoint side of the shank—resulting in a fly which is less snag-resistant than the innovation disclosed herein.

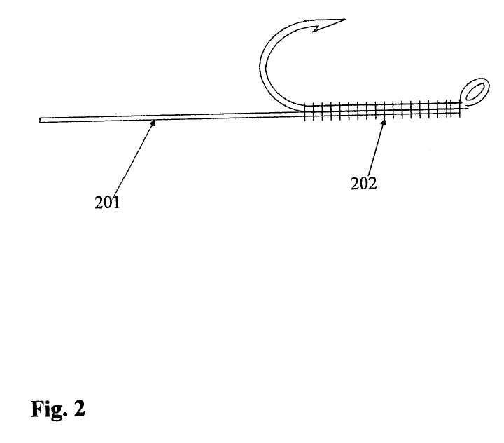

As shown in FIG. 2, the mono (201) may be lashed (202) to the shank first—with about two inches of the free end extending to the rear—then the rest of the fly is built, and finally the mono is loaded with the beads or weights and the end of the mono is bent around to be tied in at the head of the fly (109). Before tying in, the end of the mono may be crimped, or balled with a flame, to make tie-in more secure.

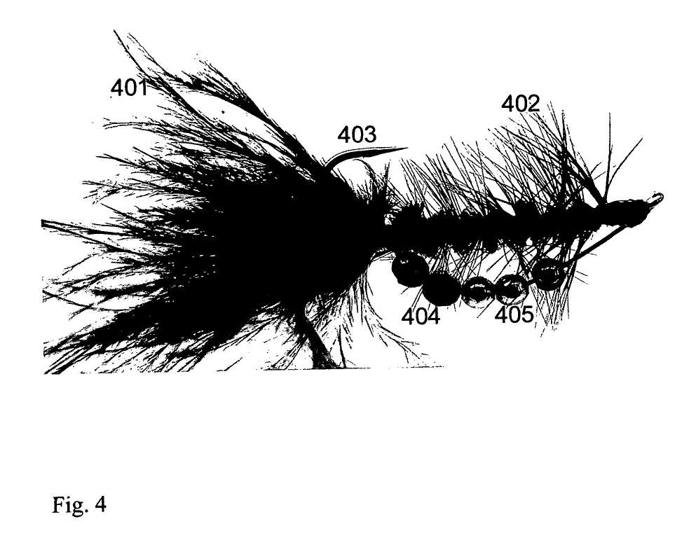

Almost any mono will do, so long as it has enough stiffness to provide torque; to provide some springiness, a satisfactory mono is one with tensile strength of 20-40 lb for larger flies, and 10-20 lb on flies sized 6-10. The mono may be round or oval in cross-section, and may be clear or colored. The beads may be varied to adjust the weight distribution; for example, in the Bouncer tied in the “WoollyBugger” style shown in FIG. 4, three brass beads (405) were used under the head and two lighter plastic beads (404) under the tail. This ability to tune the weighting can improve the action and reduce the chance that the fly will fall head down into a crack between two rocks, as sometimes happens flies made using the prior art of heavy metal eyes bound to the underside of the hook shank. In this pattern the tail (401) and hackle (402) materials are very light, so in the conventional version of this fly the heavy bend and point of the hook cause the fly to ride hookpoint down and snag-prone, but in the disclosed innovation the beads (405)—well offset from the shank of the hook—cause the fly to ride as shown.

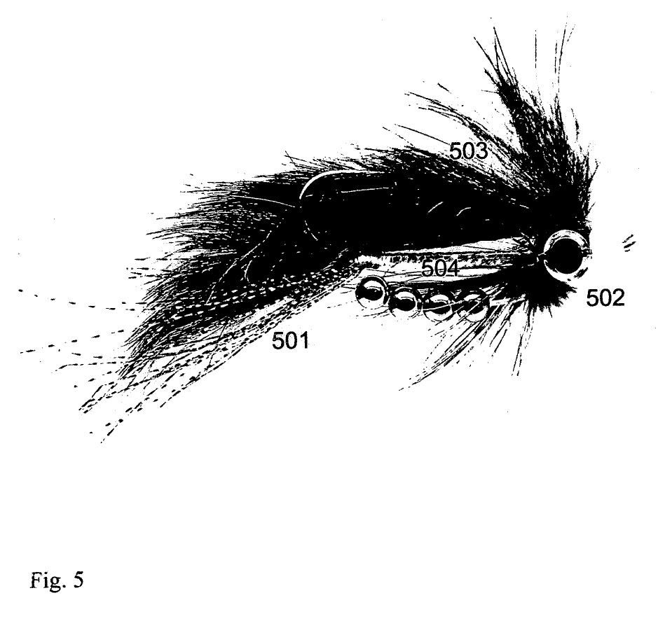

The weights used in this innovation may be less expensive than the machined parts often used in the metal weighted eyes and bead-heads of prior art; inexpensive brass, plastic and glass beads work fine. The Zonker-style Bouncer shown in FIG. 5 was made with hollow brass beads (504) used to make fishing spinners. In this example, some of the dressing of the fly was done before affixing the keel, including the tail (501) and eye (502); the wing (503) was added after affixing the keel, but before loading the keel with the beads (504). If some of the beads are heavy enough to offset the downward torque of the hook and fly body, then other beads on the keel can be made of lightweight, attractive materials, like colored plastic, phosphorescent plastic, even sequins.

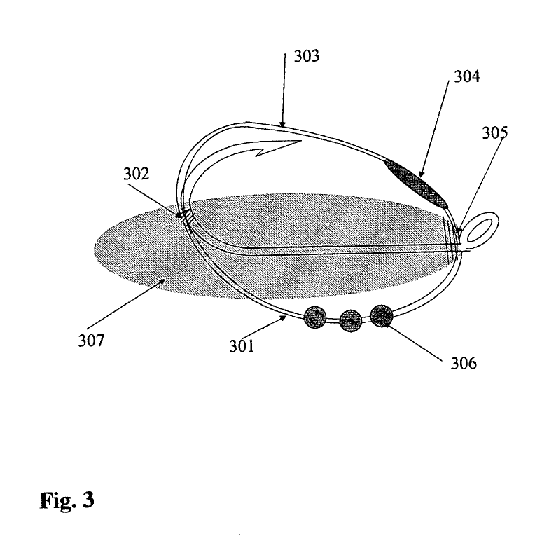

Sometimes flies are used in situations in which there many weeds on the bottom, so that a structure conventionally called a weedguard is useful. The keel structure disclosed herein is easily extended to also form a weedguard. This is accomplished by increasing the length of the filament so it can also encircle (303) the hook point in the usual weedguard position (see FIG. 3). In this embodiment, the keel filament (301) is affixed to the hook at the start of the bend (302). This method usually benefits from an adhesive like epoxy or superglue at the attachment point (302) to keep the keel from twisting around during casting. The belly loop of mono exits the shaft at a different angle than in the standard method, making it a little more difficult to tie the rest of the fly, but easier to make a shallow belly, resulting in a somewhat sleeker fly. The beads (306) are added after the main dressing (307) of the fly is complete, and then the free ends of the lower keel loop and the upper filamentary loop are tied in (305) near the eye of the hook in a manner well known to those skilled in the art of tying flies.

Note that the keel structure does not have to be made of mono—for example, wire or coated wire could be used. Many tiers prefer coated single-strand wire for weedguards, so in this case, the entire keel-weedguard structure could be made out of that material.

For some applications in which it is desired that the fly sinks slowly or even floats, some or all of the upper filamentary structure may be made of a different material than the keel filament. In particular, if part (304) of the upper loop is made of a buoyant material like foam, which is lighter than water, then there will be an additional torque to keep the hook-point riding up; this will allow the weight on the keel to be reduced, resulting in a very lightweight snag-resistant fly. In fact, if the volume of the part (304) is large enough—for example, multiple thin filamentary strips of foam, or one thick strip—then the fly may float at the water surface with the hook-point up and unlikely to snag on the weeds and debris commonly floating on the surface of the water.

The method of lashing the filament to the hook shank (202) is consistent with the thread wrapping found in non-commercial tying. It is apparent that other methods may be employed for higher-volume commercial production, including, but not limited to, adhesives, spot welding, injection molding, knotting, crimping, etc. In some circumstances, it may be preferable to build part of the fly—the tail, for example—before attaching the first end of the filamentary loop. In fact, it is possible, and may be useful for commercial production tying, to attach the loop and weights after the main dressing of the fly is completed. In this case, a preferred embodiment is to pre-form the loop structures in some manner—e.g., with crimped or tightly looped ends—so the weighted keel may be rapidly slipped on and affixed by some production method like a strong adhesive.

I claim:

1. A fishing fly, comprising in addition to the usual fly dressing materials:
a. A fishhook having a shank (103) with an eye (104) at first end and a curved portion (102) terminating in a point (101) at a second end, the curved portion and point having weight and a moment arm about a longitudinal axis of the shank,
b. A weighted loop (106) extending substantially from the first end to the second end of the shank opposite the curved portion, the weighted loop having a weight (107) and a moment arm (108) about the longitudinal axis of the shank,
wherein the product of the weight and the moment arm of the weighted loop is greater than the product of the weight and the moment arm of the curved portion.

2. The fishing fly of claim 1, wherein the weighted loop is flexible.

3. The fishing fly of claim 1 or claim 2, wherein the weighted loop comprises a filament (106) carrying a plurality of weights.

4. The fishing fly of claim 3, wherein at least one of the weights (107) is free to slide on the filament and wherein at least two adjacent weights are of a material which creates a clicking noise when the weights strike one another.

5. The fishing fly of claim 3 or claim 4, wherein at least one of the weights comprises a bead formed from a material denser than water.

6. The fishing fly of any of claims 3 to 5, wherein at least one of the weights has at least one colored or light-reflecting surface.

7. The fishing fly of any of claims 3 to 6, wherein at least one of the weights emits light.

8. The fishing fly of any of claims 3 to 7, wherein at least one of the weights comprises a sequin.

9. The fishing fly of any of claims 3 to 8, further comprising a flexible second loop (303) extending substantially from the first end to the second end of the shank, substantially parallel to a plane of the curved portion.

10. The fishing fly of any of claims 3 to 9, wherein the flexible second loop substantially encloses the curved portion and the point.

11. The fishing fly of any of claims 3 to 10, wherein the flexible second loop comprises a filament.

12. The fishing fly of any of claims 3 to 11, wherein the flexible second loop comprises at least one section of material (304) of density less than the density of water.

13. The fishing fly of any of claims 3 to 12, wherein the flexible second loop comprises a strip of synthetic foam material.

14. A method of tying a fishing fly, comprising:
a. Affixing a flexible filament (201) to a shank (202) of a fish hook, the fish hook having an eye at first end of the shank and a curved portion terminating in a point at a second end of the shank and the curved portion having a weight and a moment arm about a longitudinal axis of the shank, the filament having a first free end substantially longer than the shank,
b. Constructing the main body of the fly (105) from fur, tinsel, feathers, etc., according to general practice for the fly pattern desired,
c. Applying weights (107) to the filament,
d. Affixing the first free end to the first end (109) of the shank so as to form a loop carrying said weights such that the loop is opposite the curved portion and such that the loop has a weight and a moment arm about the longitudinal axis of the shank and such that the product of the weight and the moment arm of the weighted loop is greater than the product of the weight and the moment arm of the curved portion.

15. The method of claim 14, wherein affixing the flexible filament to the shank comprises affixing a central portion of the flexible filament to the second end of the shank (302) so that the filament further has a second free end (303) substantially longer than the shank, the method further comprising affixing the second free end to the first end of the shank (305) so as to form a loop substantially enclosing the curved portion and the point.

16. The method of claims 14-15, wherein some of the main construction of the body of the fly may precede the affixing of the flexible filament.

17. The method of claims 14-16, wherein the flexible filament is made of nylon monofilament, the weights are moveable beads and the method of affixing includes the use of adhesives.

18. The method of claims 14-17, wherein the method of affixing includes thread wrapping.
